(19) United States
(12) Patent Application Publication
(10) Pub. No.: US 2023/0419734 A1
(43) Pub. Date: Dec. 28, 2023

(54) WORK MANAGEMENT APPARATUS AND PROGRAM THEREFOR

(71) Applicant: TOSHIBA TEC KABUSHIKI KAISHA, Tokyo (JP)

(72) Inventors: Keita Yamazaki, Mishima Shizuoka (JP); Yuishi Takeno, Numazu Shizuoka (JP); Thandar Mya, Yokohama Kanagawa (JP); Takuya Kamitani, Mishima Shizuoka (JP)

(21) Appl. No.: 18/071,683

(22) Filed: Nov. 30, 2022

(30) Foreign Application Priority Data
Jun. 27, 2022 (JP) 2022-102670

(51) Int. Cl. G06V 40/20; G06V 20/52; G06Q 10/0631

(52) U.S. Cl. CPC G06V 40/28; G06V 20/52; G06Q 10/063114; G06V 2201/07

(57) ABSTRACT

A work management apparatus includes a first detecting unit, a second detecting unit, a third detecting unit, and an information acquiring unit. The first detecting unit detects that work was executed in a work area. The second detecting unit detects that the work in the work area ended. The third detecting unit detects that a hand of an operator entered an article area where an article relating to the work is placed. The information acquiring unit acquires information relating to the work in the work area if, from when the third detecting unit detects that the hand of the operator entered the article area until when the second detecting unit detects that the work in the work area ended, the first detecting unit detects that the work was executed in the work area.

### CROSS-REFERENCE TO RELATED APPLICATION

This application is based upon and claims the benefit of priority from Japanese Patent Application No. P2022-102670, filed on Jun. 27, 2022, the entire contents of which are incorporated herein by reference.

### FIELD

Embodiments described herein relate generally to a work management apparatus and a program therefor.

### BACKGROUND

There has been a technique for defining a work area in advance and, if a hand of an operator is moving in the work area, determining that work is being performed, if the hand is not moving or the hand is absent in the work area, determining that the work is not being performed, and managing an operation state of the work. By applying such a work management technique to, for example, work in which an operator assembles a product, it is possible to acquire a time required for the work and measure a delay for each kind of work with respect to a standard work time.

However, in the work management technique of the related art, it is possible to acquire a work time of the entire work but, for example, if work including a plurality of processes is performed, it is difficult to acquire a work time for each of the processes.

### DESCRIPTION OF THE DRAWINGS

FIG. 1 is a schematic configuration diagram of a work management system including a work management apparatus in an embodiment;

FIG. 2 is a schematic diagram illustrating a main data structure of operator data;

FIG. 3 is a schematic diagram illustrating a main data structure of work data;

FIG. 4 is a schematic diagram illustrating a main data structure of work log data;

FIG. 5 is a block diagram illustrating a main circuit configuration of the work management apparatus;

FIG. 6 is a schematic diagram illustrating a main memory area formed in a main memory of the work management apparatus;

FIG. 7 is a flowchart illustrating a main part procedure of information processing executed by a processor;

FIG. 8 is a flowchart illustrating the main part procedure of the information processing executed by the processor;

FIG. 9 is a flowchart illustrating the main part procedure of the information processing executed by the processor;

FIG. 10 is a flowchart illustrating the main part procedure of the information processing executed by the processor; and

FIG. 11 is a flowchart illustrating the main part procedure of the information processing executed by the processor.

### DETAILED DESCRIPTION

An aspect of embodiments is to provide a work management apparatus that can acquire, for each of a plurality of processes, work-related information of an operator for work including the plurality of processes.

In an embodiment, a work management apparatus includes a first detecting unit, a second detecting unit, a third detecting unit, and an information acquiring unit. The first detecting unit detects that work was executed in a work area. The second detecting unit detects that the work in the work area ended. The third detecting unit detects that a hand of an operator entered an article area where an article relating to the work is placed. The information acquiring unit acquires information relating to the work in the work area if, from when the third detecting unit detects that the hand of the operator entered the article area until when the second detecting unit detects that the work in the work area ended, the first detecting unit detects that the work was executed in the work area.

A work management apparatus in an embodiment is explained below with reference to the drawings.

This embodiment illustrates a work management apparatus that manages product assembly work including two processes. Specifically, the work management apparatus manages, in a work area defined in advance, assembly work including a first assembly process in which an operator assembles a product using a first component placed in a first component area and a second assembly process in which the operator assembles the product using a second component placed in a second component area.

[Explanation of a Work Management System]

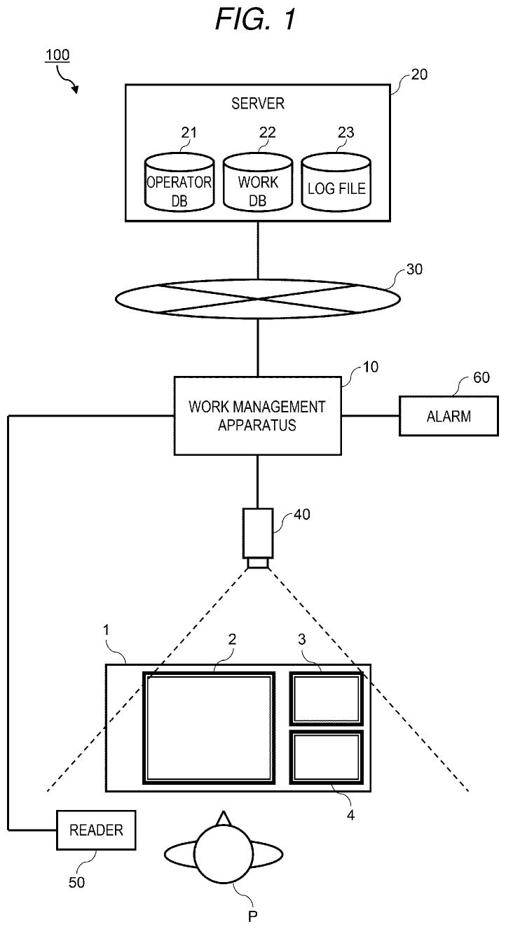

FIG. 1 is a schematic configuration diagram of a work management system 100 including a work management apparatus 10 in an embodiment. The work management system 100 manages product assembly work carried out by an operator P in a workbench 1. The workbench 1 is divided into a work area 2, a first component area 3, and a second component area 4 in advance. The work area 2, the first component area 3, and the second component area 4 do not overlap one another. The work area 2 is an area where the product assembly work is carried out by the operator P. In this embodiment, the assembly work includes a first assembly process for assembling a product using a first component and a second assembly process for assembling the product using a second component. The first component area 3 is an area for placing the first component necessary in work of the first assembly process. The second component area 4 is an area for placing the second component necessary in work of the second assembly process. Each of the first component and the second component is not limited to one type. Two or more types of the first component or the second component may be placed in the first component area 3 or the second component area 4.

The work management system 100 includes the work management apparatus 10 and a server 20. The work management apparatus 10 and the server 20 are connected via a communication network 30 to be capable of performing bidirectional communication. The communication network 30 is, for example, a wired LAN (Local Area Network) or a wireless LAN. The server 20 may be a server using Cloud computing. In that case, the communication network 30 is a wide area network using an Internet protocol. For example, the communication network 30 may be a wide area network in which a public line or a leased line is used as a relay network and a wired LAN (Local Area Network), a wireless LAN, a mobile communication network, a cellular phone communication network, or the like is used as an access network.

In the work management system 100, various devices such as a camera 40, a reader 50, and an alarm 60 are connected to the work management apparatus 10. The camera is an imaging device attached to a position where at least the work area 2, the first component area 3, and the second component area 4 of the workbench 1 can be imaged from above the workbench 1. The camera 40 is a camera for imaging a hand of the operator P who performs work in the work area 2. The camera 40 is also a camera for imaging a hand of the operator P taking out a component from the first component area 3 or the second component area 4. The camera may be a digital still camera that captures a still image or may be a video camera that captures a moving image.

The reader 50 is an input device for reading information from a medium. In this embodiment, the medium is a barcode. Accordingly, the reader 50 is a barcode reader. The reader 50 may be a stationary barcode reader or may be a handheld barcode reader.

The alarm 60 is an output device that performs an alarm operation based on information relating to work managed by the work management apparatus 10. The alarm 60 may be an alarm that performs an alarm operation to an administrator of the work or may be an alarm that performs an alarm operation to the operator P. Alternatively, the alarm 60 that performs the alarm operation to the administrator of the work and the alarm 60 that performs the alarm operation to the operator P may be concurrently used. As the alarm 60 that performs the alarm operation to the administrator of the work, a display, a touch panel, and the like are conceivable. As the alarm 60 that performs the alarm operation to the operator P, a lamp, a buzzer, and the like are conceivable. It goes without saying that the display, the touch panel, or the like may be used as the alarm 60 to the operator P and the lamp, the buzzer, or the like may be used as the alarm 60 to the administrator.

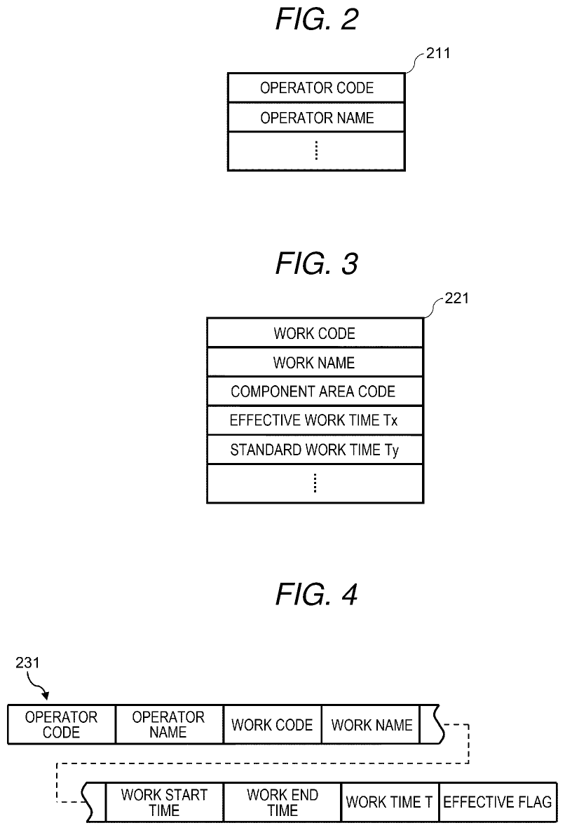

The server 20 is a server computer that provides a service to the work management apparatus 10 using an operator database 21, a work database 22, a log file 23, and the like. The operator database 21 is an aggregate of operator data 211 (see FIG. 2) created for each of operators P who are in charge of assembly work in the work area 2. The work database 22 is an aggregate of work data 221 (see FIG. 3) created for each of processes of assembly work carried out in the work area 2. The log file 23 is a region for storing work log data 231 (see FIG. 4) generated by the work management apparatus 10.

FIG. 2 is a schematic diagram illustrating a main data structure of the operator data 211. As illustrated, the operator data 211 includes items such as an operator code and an operator name. The operator code is a unique identification code set for each of operators in order to individually identify the operators P. The operator name is a name of the operator identified by the operator code.

FIG. 3 is a schematic diagram illustrating a main data structure of the work data 221. As illustrated, the work data 221 includes items such as a work code, a work name, a component area code, an effective work time Tx, and a standard work time Ty. The work code is a unique identification code set for each of processes in order to individually identify processes of assembly work carried out in the work area 2. The work name is a name of the process identified by the work code. For example, a first assembly process, a second assembly process, and the like can be the work name. The component area code is a unique identification code set for each of component areas in order to individually identify the first component area 3 and the second component area 4. The effective work time Tx is a shortest time enough for deciding that assembly work of the process identified by the work code was executed. The standard work time Ty is a standard required time required for the operator to carry out assembly work of the process identified by the work code in the work area 2. The effective work time Tx is a time shorter than the standard work time Ty by several %. A value of several % is optional.

FIG. 4 is a schematic diagram illustrating a main data structure of the work log data 231. As illustrated, the work log data 231 includes items such as an operator code, an operator name, a work code, a work name, work start time, work end time, a work time T, and an effective flag F. The operator code and the operator name are obtained from the operator data 211. The work code and the work name are obtained from the work data 221. The work start time, the work end time, the work time T, and the effective flag F are derived in the work management apparatus 10. The work start time and the work end time are work start time and work end time of a process identified by the work code by an operator identified by the operator code. The work time T is an elapsed time from the work start time to the work end time. The effective flag F is one-bit data for distinguishing whether work relating to the work log data 231 is effective work. The effective work is work authorized as being surely carried out in the work area 2. In this embodiment, the effective flag F representing the effective work is represented as “1” and the effective flag F indicating ineffective work is represented as “0”.

[Configuration Explanation of the Work Management Apparatus]

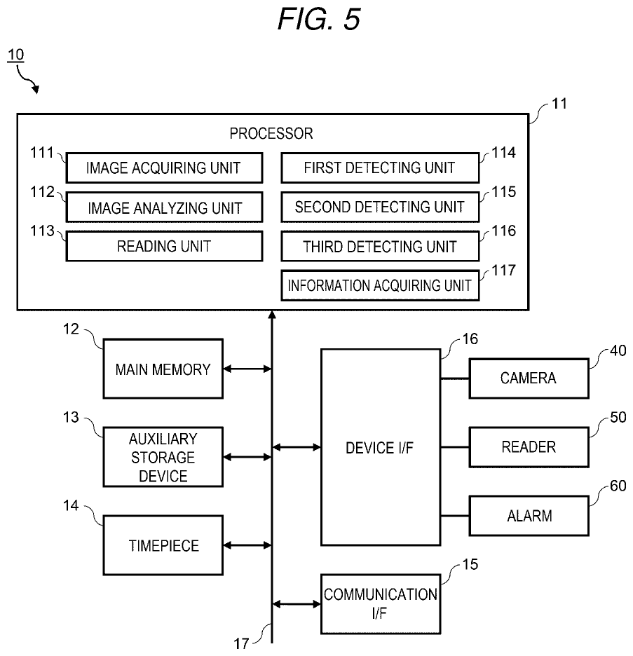

FIG. 5 is a block diagram illustrating a main part circuit configuration of the work management apparatus 10. The work management apparatus 10 includes a processor 11, a main memory 12, an auxiliary storage device 13, a timepiece 14, a communication interface 15, a device interface 16, and a system transmission line 17. The system transmission line 17 includes an address bus, a data bus, and a control signal line. In the work management apparatus 10, the processor 11, the main memory 12, the auxiliary storage device 13, the timepiece 14, the communication interface 15, and the device interface 16 are connected to the system transmission line 17. In the work management apparatus 10, a computer is configured by the processor 11, the main memory 12, the auxiliary storage device 13, the timepiece 14, the communication interface 15, and the device interface 16 and the system transmission line 17 that connects the foregoing.

The processor 11 is equivalent to a central part of the computer. The processor 11 controls the units in order to realize various functions of the work management apparatus 10 according to an operating system or application programs (application software). The processor 11 is, for example, a CPU (Central Processing Unit).

The main memory 12 is equivalent to a main storage part of the computer. The main memory 12 includes a nonvolatile memory region and a volatile memory region. the main memory 12 stores the operating system or the application programs in the nonvolatile memory region. The main memory 12 stores, in the volatile memory region, data necessary for the processor 11 in executing processing for controlling the units. The data is sometimes stored in the nonvolatile memory region. The main memory 12 uses the volatile memory region as a work area where data is rewritten as appropriate by the processor 11. The nonvolatile memory region is, for example, a ROM (Read Only Memory). The volatile memory region is, for example, a RAM (Random Access Memory).

The auxiliary storage device 13 is equivalent to an auxiliary storage part of the computer. For example, an EEPROM (Electric Erasable Programmable Read-Only Memory), a HDD (Hard Disc Drive), or an SSD (Solid State Drive) can be the auxiliary storage device 13. The auxiliary storage device 13 stores, for example, data used by the processor 11 in performing various kinds of processing or data created by the processing in the processor 11. The auxiliary storage device 13 sometimes stores the application programs.

The timepiece 14 clocks a date and time. The work management apparatus 10 acquires, as a date and time at the present point in time, the date and the time clocked by the timepiece 14.

The communication interface 15 is a circuit for performing transmission and reception of data according to a predetermined communication protocol to and from the server 20 connected to the communication interface 15 via the communication network 30.

The device interface 16 is a circuit for transmitting and receiving data signals to and from the camera 40, the reader 50, and the alarm 60 connected to the work management apparatus 10.

In the work management apparatus 10 having such a configuration, the processor 11 has functions of an image acquiring unit 111, an image analyzing unit 112, a reading unit 113, a first detecting unit 114, a second detecting unit 115, a third detecting unit 116, and an information acquiring unit 117. The image acquiring unit 111 is a function of acquiring a captured image from the camera 40 that images the work area 2. The image analyzing unit 112 is a function of detecting the position of a hand of the operator P from the captured image. The reading unit 113 is a function of reading information from a medium in cooperation with the reader 50.

The first detecting unit 114 is a function of detecting that work was executed in the work area 2. Specifically, if the hand of the operator P detected by the image analyzing unit 112 is located in the work area 2 for a predetermined time or longer, the first detecting unit 114 detects that work was executed in the work area 2.

The second detecting unit 115 is a function of detecting that the work in the work area 2 ended. The third detecting unit 116 is a function of detecting that the hand of the operator P entered the first component area 3 or the second component area 4 where a component relating to the work is placed. The function is used in the second detecting unit 115. That is, if the third detecting unit 116 detects that the hand of the operator P entered the second component area 4 after detecting that the hand of the operator P entered the first component area 3, the second detecting unit 115 detects that work relating to the first component placed in the first component area 3 in the work area 2, that is, work of the first assembly process ended. If the third detecting unit 116 detects that the hand of the operator P entered the first component area 3 after detecting that the hand of the operator P entered the second component area 4, the second detecting unit 115 detects that work relating to the second component placed in the second component area 4 in the work area 2, that is, work of the second assembly process ended. The second detecting unit 115 sometimes detects based on a reading result of medium information by the reading unit 113 that work in the work area 2 ended.

The information acquiring unit 117 is a function of acquiring information relating to the work in the work area 2 if, from when the third detecting unit 116 detects that the hand of the operator P entered the first component area 3 or the second component area 4 until when the second detecting unit 115 detects that the work in the work area 2 ended, the first detecting unit 114 detects that the work was executed in the work area 2. The information relating to the work is, for example, the work time T. That is, the information acquiring unit 117 acquires, as the work time T in the work area 2, an elapsed time from a point in time when the third detecting unit 116 detects that the hand of the operator P entered the first component area 3 or the second component area 4 until a point in time when the second detecting unit 115 detects that the work in the work area 2 ended.

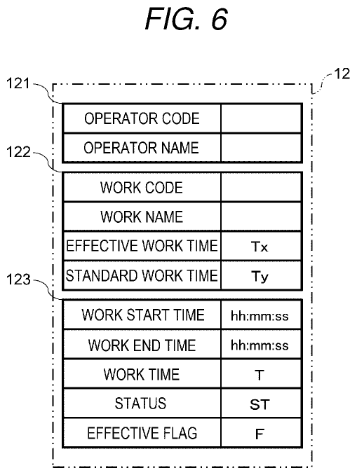

In order to realize the functions 111 to 117 explained above, as illustrated in FIG. 6, the work management apparatus 10 uses a part of the volatile memory region in the main memory 12 as an operator data area 121, a work data area 122, and a log data area 123. The operator data area 121 is a memory area for storing an operator code and an operator name of the operator P. The work data area 122 is a memory area for storing a work code, an operator name, an effective work time Tx, and a standard work time Ty of work in a process unit executed by the operator P. The log data area 123 is a memory area for storing the work start time, the work end time, the work time T, the status ST, and the effective flag F of the work log data 231.

The status ST is a value representing a state of work. As the state of the work, there are a pre-work state before the work is started, a component take-out state in which a component is taken out from the first component area 3 or the second component area 4, and a work-in-progress state in which the work is being performed in the work area 2. In this embodiment, the status ST representing the pre-work state is represented as “0”, the status ST representing the component take-out state is represented as “1”, and the status ST representing the work-in-progress state is represented as “2”.

The functions of the image acquiring unit 111, the image analyzing unit 112, the reading unit 113, the first detecting unit 114, the second detecting unit 115, the third detecting unit 116, and the information acquiring unit 117 are realized by the processor 11 executing information processing according to a control program. The control program is installed in the main memory 12 or the auxiliary storage device 13. A method of installing the control program in the main memory 12 or the auxiliary storage device 13 is not particularly limited. The control program can be recorded in a removable recording medium or distributed by communication via a network and installed in the main memory 12 or the auxiliary storage device 13. A form of the recording medium does not matter if the recording medium can store a program and can be read by an apparatus like an SSD memory card, a USB memory, or the like.

[Explanation of a Work Procedure]

A basic procedure of work managed by the work management apparatus 10 is explained.

First, the operator P carries two types of media, that is, a start medium and an end medium. The start medium is a medium obtained by converting start data indicating the start medium into a barcode. The start data includes an operator code of the operator P who carries the start medium. The end medium is a medium obtained by converting end data indicating the end medium into a barcode. The end data may or may not include the operator code of the operator P. For example, if a sheet-like member such as paper, a thin plate, or a plastic card on which the barcode of the start data or the end data is printed is used as the start medium and the end medium, convenience of use is high.

First, if coming to the front of the workbench 1, the operator P holds the start medium over the reader 50. If the start medium is held over the reader 50, the barcode of the start data is read. Subsequently, the operator P starts work from the first assembly process. That is, the operator P extends a hand to the first component area 3 and takes out the first component necessary in the work of the first assembly process. The operator P assembles a product using the first component in the work area 2. At this time, the operator P sometimes extends the hand to the first component area 3 again according to necessity and supplies the first component.

If the work of the first assembly process ends, the operator P shifts to the work of the second assembly process. That is, the operator P extends the hand to the second component area 4 and takes out the second component necessary for the work of the second assembly process. The operator P assembles the product using the second component in the work area 2. At this time as well, the operator P sometimes extends the hand to the second component area 4 again according to necessity and supplies the second component.

If the work of the second assembly process ends, the operator P returns to the work of the first assembly process. That is, the operator P extends the hand to the first component area 3 and takes out the first component necessary in the work of the first assembly process. The operator P assembles the product using the first component in the work area 2.

Thereafter, the operator P alternately repeatedly executes the work of the first assembly process and the work of the second assembly process. If all the work ends, the operator P holds the end medium over the reader 50 and then leaves the front of the workbench 1. If the end medium is held over the reader 50, the barcode of the end data is read.

The operator P can also leave the front of the workbench 1 once at a stage when the work of the first assembly process ends. In that case as well, the operator P holds the end medium over the reader 50 and then leaves the front of the workbench 1. If returning to the work, the operator P holds the start medium over the reader 50 and then starts the work of the second assembly process.

[Operation Explanation of the Work Management Apparatus]

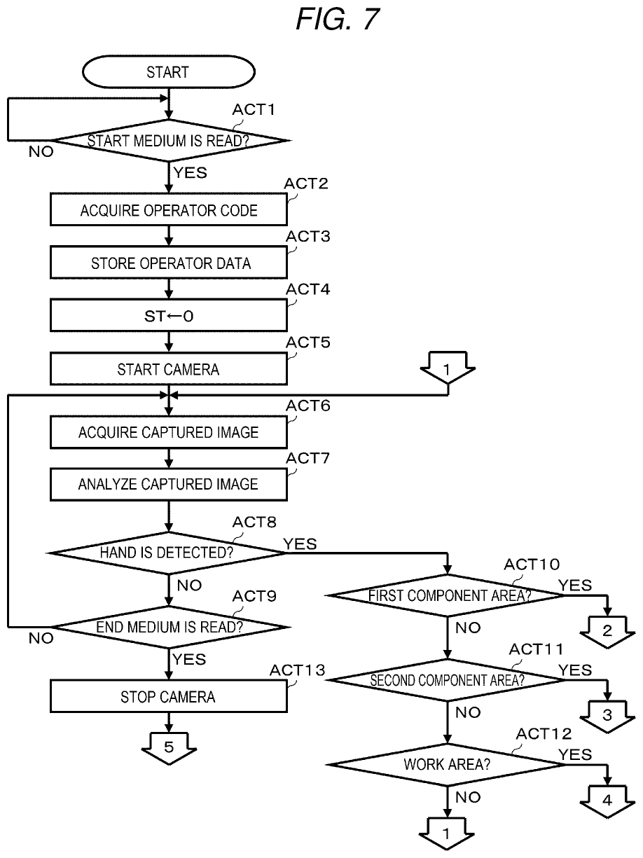

Subsequently, the operation of the work management apparatus 10 configured to manage the work performed according to the procedure explained above is explained with reference to flowcharts of FIGS. 7 to 11.

FIGS. 7 to 11 are flowcharts illustrating a main part procedure of information processing executed by the processor 11 according to a control program. The procedure of the information processing indicated by the flowcharts is an example. The procedure and content of the procedure can be changed as appropriate if the same action effects can be obtained.

If the work management apparatus 10 starts, the processor 11 starts the information processing of the procedure illustrated in the flowchart of FIG. 7. First, in ACT 1, the processor 11 waits for information of the start medium, that is, the barcode of the start data to be read by the reader 50. If the operator P holds the start medium over the reader 50 and the barcode of the start data is read, the processor 11 proceeds from ACT 1 to ACT 2. In ACT 2, the processor 11 acquires an operator code from the barcode of the start data. In ACT 3, the processor 11 acquires, from the server 20, operator data of the operator P identified by the operator code and stores the operator data in the operator data area 121.

Specifically, the processor 11 controls the communication interface 15 to transmit an inquiry command for operator data. According to the control, the inquiry command is transmitted from the communication interface 15. The inquiry command is transmitted to the server 20 via the communication network 30. The inquiry command includes the operator code acquired from the barcode of the start data. The server 20 searches through the operator database 21 with the operator code included in the inquiry command. The server 20 reads out the operator data 211 including the operator code from the operator database 21. The server 20 transmits a response command including the operator data 211 to the work management apparatus 10 at an inquiry command transmission source. The processor 11 waits for the response command transmitted from the server 20. If receiving the response command via the communication interface 15, the processor 11 acquires the operator data 211 from the response command. The processor 11 describes the operator code and the operator name of the operator data 211 in the operator data area 121.

If finishing the processing in ACT 3, the processor 11 proceeds to ACT 4. In ACT 4, the processor 11 describes a value “0” representing the pre-work state in the log data area 123 as the status ST. In ACT 5, the processor 11 outputs an ON signal to the camera 40. The camera 40 to which the ON signal is input starts and imaging is started. As a result, images captured by the camera 40 are sequentially fed into the work management apparatus 10.

In ACT 6, the processor 11 acquires an image captured by the camera 40 via the device interface 16. In ACT 7, the processor 11 analyzes the captured image. In ACT 8, as a result of analyzing the captured image, the processor 11 checks whether a movement of the hand of the operator P is detected. To detect a movement of the hand of the operator P from the captured image, a well-known image analysis technique only has to be applied.

If a movement of the hand of the operator P cannot be detected, the processing 11 proceeds to ACT 9. In ACT 9, the processor 11 checks whether the information of the end medium, that is, the barcode of the end data is read by the reader 50. If the barcode of the end data is not read, the processor 11 returns to ACT 6. In this way, according to the processing in ACT 6 to ACT 9, the processor 11 waits for a movement of the hand of the operator P to be detected or the information of the end medium to be read.

If a movement of the hand of the operator P is detected in the waiting state in ACT 6 to ACT 9, the processor 11 proceeds from ACT 8 to ACT 10. In ACT 10 to ACT 12, the processor 11 discriminates an area where the movement of the hand of the operator P is detected. That is, in ACT 10, the processor 11 checks whether a movement of the hand of the operator P is detected in the first component area 3. If a movement of the hand of the operator P is not detected, in ACT 11, the processor 11 checks whether a movement of the hand of the operator P is detected in the second component area 4. If a movement of the hand of the operator P is not detected, in ACT 12, the processor 11 checks whether a movement of the hand of the operator P is detected in the work area 2. If a movement of the hand of the operator P is not detected, the processor 11 returns to the waiting state in ACT 6 to ACT 9. That is, if a movement of the hand of the operator P is detected in an area other than the work area 2, the first component area 3, or the second component area 4, the processor 11 waits for a movement of the hand of the operator P to be detected again or the information of the end medium to be read again.

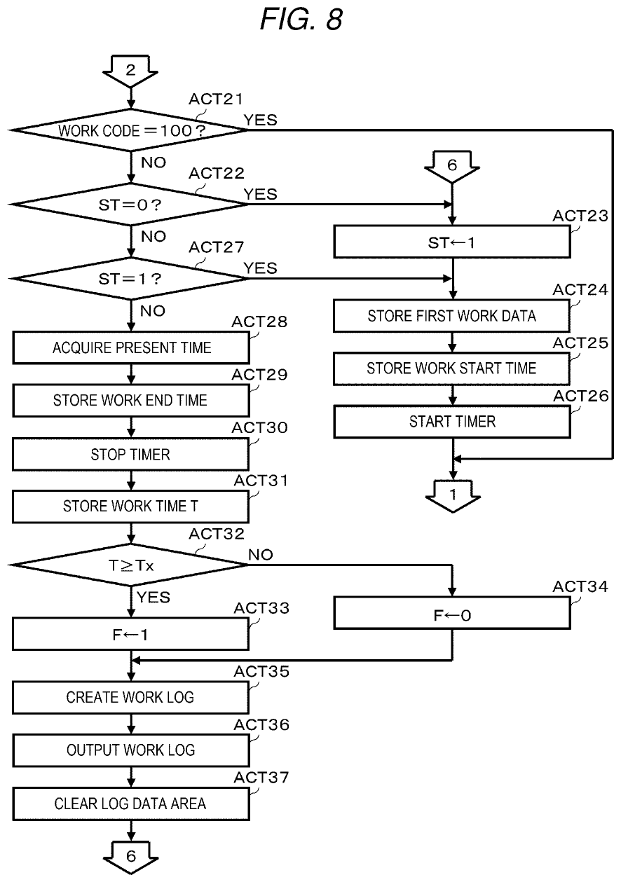

If the operator P who held the start medium over the reader 50 extends the hand to the first component area 3 in order to start the work of the first assembly process, a movement of the hand of the operator P is detected in the first component area 3 from the captured image by the camera 40. If the movement of the hand of the operator P is detected in the first component area 3, the processor 11 proceeds from ACT 10 to ACT 21 in FIG. 8. In ACT 21, the processor 11 checks whether a work code “100” is described in the work data area 122. The work code “100” is a work code for identifying a first work process. Incidentally, a work code for identifying a second work process is “200”.

At this point in time, the work code “100” is not described in the work data area 122. Therefore, the processor 11 proceeds from ACT 21 to ACT 22. In ACT 22, the processor 11 checks whether the status ST of the log data area 123 is the value “0” representing the pre-work state. At this point in time, the status ST is “0”. Therefore, the processor 11 proceeds from ACT 22 to ACT 23. In ACT 23, the processor 11 rewrites the status ST from “0” to the value “1” representing the component takeout state. In ACT 24, the processor 11 describes work data of the first work process identified by the work code “100” in the work data area 122.

Specifically, the processor 11 controls the communication interface 15 to transmit an inquiry command for work data. According to the control, the inquiry command is transmitted from the communication interface 15. The inquiry command is transmitted to the server 20 via the communication network 30. The inquiry command includes the work code “100”. The server 20 searches through the work database 22 with the work code included in the inquiry command. The server 20 reads out the work data 221 including the work code “100” from the work database 22. The server 20 transmits a response command including the work data 221 to the work management apparatus 10 at an inquiry command transmission source. The processor 11 waits for the response command transmitted from the server 20. If receiving the response command via the communication interface 15, the processor 11 acquires the work data 221 from the response command. The processor 11 describes the work code, the work name, the effective work time Tx, and the standard work time Ty of the work data 221 in the work data area 122.

The processor 11 that finished the processing in ACT 24 proceeds to ACT 25. In ACT 25, the processor 11 takes in time at the present point in time clocked by the timepiece 14 and describes the time in the log data area 123 as the work start time. In ACT 26, the processor 11 starts a timer. The timer is a timer for clocking the work time T and is built in, for example, the processor 11.

If finishing the processing in ACT 26, the processor 11 returns to the waiting state in ACT 6 to ACT 9. Therefore, if a movement of the hand of the operator P is continuously detected in the first component area 3 from the captured image by the camera 40, the processor 11 proceeds from ACT to ACT 21 in FIG. 8. At this point in time, since the work code “100” is described in the work data area 122, the processor 11 returns from ACT 21 to the waiting state in ACT 6 to ACT 9. In this way, after the movement of the hand of the operator P is detected in the first component area 3 and the processing in ACT 23 to ACT 26 is executed, the processor 11 maintains the waiting state in ACT 6 to ACT 9 until the movement of the hand of the operator P is not detected any more in the first component area 3.

On the other hand, if the operator P who held the starting medium over the reader 50 extends the hand to the second component area 4 in order to start the work of the second assembly process, a movement of the hand of the operator P is detected in the second component area 4 from the captured image by the camera 40.

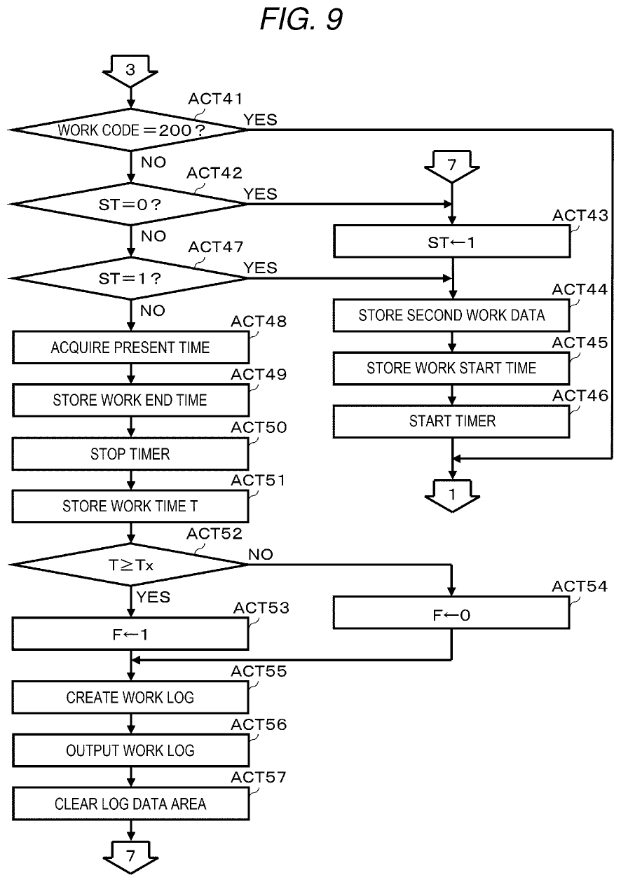

If a movement of the hand of the operator P is detected in the second component area 4 in the waiting state in ACT 6 to ACT 9, the processor 11 proceeds from ACT 11 to ACT 41 in FIG. 9. In ACT 41, the processor 11 determines whether the work code “200” is described in the work data area 122.

At this point in time, the work code “200” is not described in the work data area 122. Therefore, the processor 11 proceeds from ACT 41 to ACT 42. In ACT 42, the processor 11 checks whether the status ST of the log data area 123 is the value “0” representing the pre-work state. At this point in time, the status ST is “0”. Therefore, the processor 11 proceeds from ACT 42 to ACT 43. In ACT 43, the processor 11 rewrites the status ST from “0” to the value “1” representing the component take-out state. In ACT 44, the processor 11 describes work data of the second work process identified by the work code “200” in the work data area 122.

Specifically, the processor 11 controls the communication interface 15 to transmit an inquiry command for work data. According to the control, the inquiry command is transmitted from the communication interface 15. The inquiry command is transmitted to the server 20 via the communication network 30. The inquiry command includes the work code “200”. The server 20 searches through the work database 22 with the work code included in the inquiry command. The server 20 reads out the work data 221 including the work code “200” from the work database 22. The server 20 transmits a response command including the work data 221 to the work management apparatus 10 at an inquiry command transmission source. The processor 11 waits for the response command transmitted from the server 20. If receiving the response command via the communication interface 15, the processor 11 acquires the work data 221 from the response command. The processor 11 describes the work code, the work name, the effective work time Tx, and the standard work time Ty of the work data 221 in the work data area 122.

The processor 11 that finished the processing in ACT 44 proceeds to ACT 45. In ACT 45, the processor 11 takes in time at the present point in time clocked by the timepiece 14 and describes the time in the log data area 123 as the work start time. In ACT 46, the processor 11 starts the timer.

If finishing the processing in ACT 46, the processor 11 returns to the waiting state in ACT 6 to ACT 9. Therefore, if a movement of the hand of the operator P is continuously detected in the second component area 4 from the captured image by the camera 40, the processor 11 proceeds from ACT 11 to ACT 41 in FIG. 9. At this point in time, since the work code “200” is described in the work data area 122, the processor 11 returns from ACT 41 to the waiting state in ACT 6 to ACT 9. In this way, after the movement of the hand of the operator P is detected in the second component area 4 and the processing in ACT 43 to ACT 46 is executed, the processor 11 maintains the waiting state in ACT 6 to ACT 9 until the movement of the hand of the operator P is not detected any more in the second component area 4.

If the operator P who took out the first component from the first component area 3 starts the work of the first assembly process in the work area 2, a movement of the hand of the operator P is detected in the work area 2 from the captured image by the camera 40. Similarly, if the operator P who took out the second component from the second component area 4 starts the work of the second assembly process in the work area 2, a movement of the hand of the operator P is also detected in the work area 2 from the captured image by the camera 40.

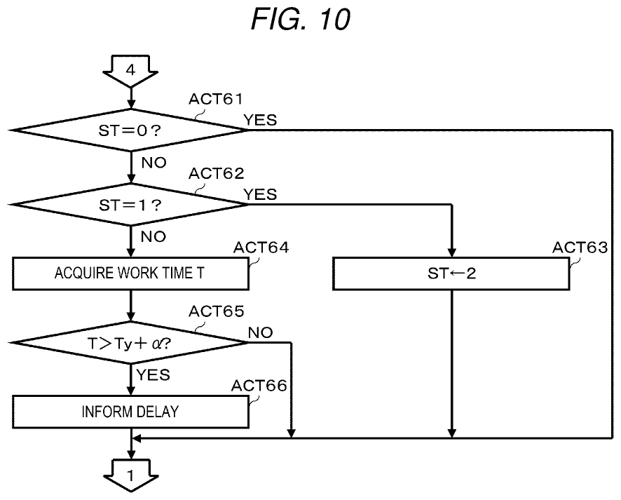

If a movement of the hand of the operator P is detected in the work area 2 in the waiting state in ACT 6 to ACT 9, the processor 11 proceeds from ACT 12 to ACT 61 in FIG. 10. In ACT 61, the processor 11 checks whether the status ST of the log data area 123 is the value “0” representing the pre-work state. At this point in time, since the status ST is “1” representing the component take-out state, the processor 11 proceeds from ACT 61 to ACT 62.

A movement of the hand of the operator P is sometimes detected in the work area 2 from the captured image by the camera 40 because the operator P moves the hand in the work area 2 before taking out the first component or the second component from the first component area 3 or the second component area 4. In this case, since the status ST is “0” in ACT 61, the processor 11 returns to the waiting state in ACT 6 to ACT 9.

If the status ST is not “0” in ACT 61, in ACT 62, the processor 11 checks whether the status ST is “1”. The status ST being “1” means that a movement of the hand of the operator P is detected in the work area 2 after a movement of the hand of the operator P is detected in the first component area 3 or the second component area 4. Therefore, the operator P who took out the first component or the second component from the first component area 3 or the second component area 4 is considered to have started the work of the first assembly process or the second assembly process.

If the status ST is “1”, the processor 11 proceeds from ACT 62 to ACT 63. In ACT 63, the processor 11 rewrites the status ST from “1” to the value “2” representing work-in-progress state. Thereafter, the processor 11 returns to the waiting state in ACT 6 to ACT 9. Therefore, if a movement of the hand of the operator P is continuously detected in the work area 2 from an image captured by the camera 40 in the waiting state in ACT 6 to ACT 9, since the status ST is “2”, the processor 11 proceeds from ACT 62 to ACT 64.

In ACT 64, the processor 11 acquires a clocked time of the timer as the work time T. In ACT 65, the processor 11 checks whether the work time T exceeded a time (Ty+α) obtained by adding a predetermined delay time α to the standard work time Ty described in the work data area 122. The delay time α is any time. The delay time α may be one minute, two minutes, three minutes, or the like or may be a time longer than these times. The delay time α may be zero minute. If the work time T did not exceed the time (Ty+α), the processor 11 returns to the waiting state in ACT 6 to ACT 9.

In contrast, if the work time T exceeded the time (Ty+α), the processor 11 proceeds to ACT 66. In ACT 66, the processor 11 causes the alarm 60 to operate and informs that the work is delayed. Thereafter, the processor 11 returns to the waiting state in ACT 6 to ACT 9.

In this way, for example, if the work time T of the first assembly process exceeded the time (Ty+α) obtained by adding the predetermined delay time α to the standard work time Ty of the first assembly process, the alarm 60 operates. According to the operation, the operator P can aware that the work of the first assembly process is delayed behind the standard work time Ty. Alternatively, the administrator can grasp that the work of the first assembly process by the operator P is delayed with respect to the standard work time Ty. Such an operation is the same if the work is work of the second assembly process.

If finishing the work of the first assembly process and shifting to the work of the second assembly process, the operator P extends the hand to the second component area 4. At this time, the work code described in the work data area 122 is “100” and the status ST described in the log data area 123 is “2”. Therefore, if a movement of the hand of the operator P is detected in the second component area 4 from the captured image by the camera 40, the processor 11 determines NO in ACT 41 in FIG. 9, determines NO in ACT 42, and proceeds to ACT 47. In ACT 47, the processor 11 checks whether the status ST is “1”. In this case, since the status ST is “2”, the processor 11 proceeds from ACT 47 to ACT 48.

In ACT 48, the processor 11 takes in time at the present point in time clocked by the timepiece 14. In ACT 49, the processor 11 describes the time at the present point in time in the log data area 123 as the work end time. In ACT 50, the processor 11 stops the timer. In ACT 51, the processor 11 describes the work time T in the log data area 123. The work time T may be a clocked time by the timer or may be an elapsed time from work start time to work end time of the log data area 123.

In ACT 52, the processor 11 compares the work time T with the effective work time Tx of the first assembly process described in the work data area 122. As a result, if the work time T is equal to or longer than the effective work time Tx, the processor 11 proceeds from ACT 52 to ACT 53. In ACT 53, the processor 11 describes the effective flag F of “1” in the log data area 123. In contrast, if the work time T is shorter than the effective work time Tx, the processor 11 proceeds from ACT 52 to ACT 54. In ACT 54, the processor 11 describes the effective flag F of “0” in the log data area 123.

If finishing the processing in ACT 53 or ACT 54, the processor 11 proceeds to ACT 55. In ACT 55, the processor 11 creates the work log data 231. That is, the processor 11 creates the work log data 231 from the operator code and the operator name of the operator data area 121, the work code and the work name of the work data area 122, and the work start time, the work end time, the work time T, and the effective flag F of the log data area 123.

In ACT 56, the processor 11 controls the communication interface 15 to transmit and output the work log data 231 to the server 20. According to the control, the work log data 231 is transmitted to the server 20 via the communication network 30. The work log data 231 is stored in the log file 23 by the action of the server 20.

The processor 11 of the work management apparatus 10 that outputted the work log data 231 proceeds to ACT 57. In ACT 57, the processor 11 clears data of the log data area 123. Thereafter, the processor 11 proceeds to ACT 43. The processor 11 executes the processing in ACT 43 to ACT 46 in the same manner as explained above. That is, the processor 11 rewrites the status ST from “2” to the value “1” representing the component take-out state. The processor 11 describes the work data of the second work process identified by the work code “200” in the work data area 122. Further, the processor 11 describes time at the present point in time clocked by the timepiece 14 in the log data area 123 as the work start time. Thereafter, the processor 11 starts the timer and returns to the waiting state in ACT 6 to ACT 9.

In this way, if shifting from the work of the first assembly process to the work of the second assembly process, the processor 11 creates the work log data 231 and outputs the work log data 231 to the server 20. The work log data includes the operator code and the operator name as the information concerning the operator P and includes the work code and the work name of the first work process as the information concerning the work. The work log data also includes the work start time, the work end time, the work time T, and the effective flag F as the work management data. If the work time T is equal to or longer than the effective work time Tx, the effective flag F is the value “1” representing effective work. If the work time T is shorter than the effective work time Tx, the effective flag F is the value “0” representing ineffective work.

If finishing the work of the second assembly process and shifting to the work of the first assembly process, the operator P extends the hand to the first component area 3. At this time, the work code described in the work data area 122 is “200” and the status ST described in the log data area 123 is “2”. Therefore, if a movement of the hand of the operator P is detected in the first component area 3 from the captured image by the camera 40, the processor 11 determines NO in ACT 21 in FIG. 8, determines NO in ACT 22 as well, and proceeds to ACT 27. In ACT 27, the processor 11 determines whether the status ST is “1”. In this case, since the status ST is “2”, the processor 11 proceeds from ACT 27 to ACT 28.

Thereafter, the processor 11 executes the same processing as the processing in ACT 48 to ACT 57 explained above with reference to FIG. 9. That is, in ACT 28, the processor 11 takes in time at the present point in time clocked by the timepiece 14. In ACT 29, the processor 11 describes the time at the present point in time in the log data area 123 as the work end time. In ACT 30, the processor 11 stops the timer. In ACT 31, the processor 11 describes the work time T in the log data area 123. In this case as well, the work time T may be a clocked time by the timer or may be an elapsed time from the work start time to the work end time of the log data area 123.

In ACT 32, the processor 11 compares the work time T with the effective work time Tx of the second assembly process described in the work data area 122. As a result, if the work time T is equal to or longer than the effective work time Tx, in ACT 33, the processor 11 describes the effective flag F of “1” in the log data area 123. In contrast, if the work time T is shorter than the effective work time Tx, in ACT 34, the processor 11 describes the effective flag F of “0” in the log data area 123.

If finishing the processing in ACT 33 or ACT 34, in ACT 35, the processor 11 creates the work log data 231. In ACT 36, the processor 11 controls the communication interface 15 to transmit and output the work log data 231 to the server 20. After outputting the work log data 231, in ACT 37, the processor 11 clears the data of the log data area 123. The processor 11 executes the processing in ACT 23 to ACT 26 in the same manner as explained above. That is, the processor 11 rewrites the status ST from “2” to the value “1” representing the component take-out state. The processor 11 describes, in the work data area 122, the work data of the first work process identified by the work code “100”. Further, the processor 11 describes time at the present point in time clocked by the timepiece 14 in the log data area 123 as the work start time. Thereafter, the processor 11 starts the timer and returns to the waiting state in ACT 6 to ACT 9.

In this way, if shifting from the work of the second assembly process to the work of the first assembly process as well, the processor 11 creates the work log data 231 and outputs the work log data 231 to the server 20. If the work time T is equal to or longer than the effective work time Tx of the second assembly process, the effective flag F of the work log data 231 is the value “1” representing effective work. If the work time T is shorter than the effective work time Tx, the effective flag F of the work log data 231 is the value “0” representing ineffective work.

The operator P who finished the work of the first assembly process or the second assembly process holds the end medium over the reader 50. If information of the end medium is read in the waiting state in ACT 6 to ACT 9, the processor 11 proceeds to ACT 13. In ACT 13, the processor 11 outputs an OFF signal to the camera 40. The camera 40 to which the OFF signal is input stops and the imaging operation ends.

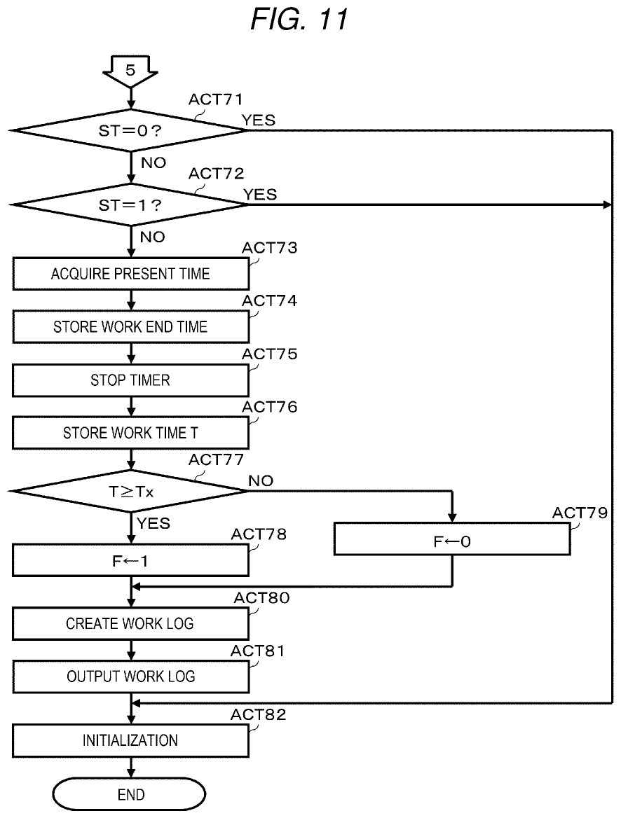

If the imaging operation ends, the processor 11 proceeds to ACT 71 in FIG. 11. In ACT 71, the processor 11 checks whether the status ST of the log data area 123 is “0”. At this point in time, since the status ST is not “0”, the processor 11 proceeds to ACT 72. In ACT 72, the processor 11 checks whether the status ST of the log data area 123 is “1”. At this point in time, the status ST is not “1” either. That is, the status ST is “2”. Therefore, the processor 11 proceeds to ACT 73. In ACT 73 to ACT 81, the processor 11 executes the same processing as the processing in ACT 28 to ACT 36 explained with reference to FIG. 8 or ACT 48 to ACT 56 explained with reference to FIG. 9.

That is, in ACT 73, the processor 11 takes in time at the present point in time clocked by the timepiece 14. In ACT 74, the processor 11 describes the time at the present point in time in the log data area 123 as the work end time. In ACT 75, the processor 11 stops the timer. In ACT 76, the processor 11 describes the work time T in the log data area 123.

In ACT 77, the processor 11 compares the work time T with the effective work time Tx described in the work data area 122. If the operator P holds the end medium over the reader 50 after finishing the first work process, the effective work time Tx is an effective work time of the first work process. If the operator P holds the end medium over the reader 50 after finishing the second work process, the effective work time Tx is an effective work time of the second work process. If the work time T is equal to or longer than the effective work time Tx, in ACT 78, the processor 11 describes the effective flag F of “1” in the log data area 123. In contrast, if the work time T is shorter than the effective work time Tx, in ACT 79, the processor 11 describes the effective flag F of “0” in the log data area 123.

If finishing the processing in ACT 78 or ACT 79, in ACT 80, the processor 11 creates the work log data 231. In ACT 81, the processor 11 controls the communication interface 15 to transmit and output the work log data 231 to the server 20.

The processor 11 that outputted the work log data 231 to the work management apparatus 10 proceeds to ACT 82. In ACT 82, the processor 11 performs initialization. According to the initialization, the operator data area 121, the work data area 122, and the log data area 123 of the main memory 12 are cleared. Then, the processor 11 ends the information processing indicated by the flowcharts of FIGS. 7 to 11.

In this connection, the operator P who held the start medium over the reader 50 sometimes holds the end medium over the reader 50 without performing work. In this case, the status ST is “0”. The operator P who extended the hand to the first component area 3 or the second component area 4 after holding the start medium over the reader 50 sometimes holds the end medium over the reader 50 without performing work. In this case, the status ST is “1”.

If information of the end medium is read in a state in which the status ST is “0” or “1”, the processor 11 skips the processing in ACT 73 to ACT 81 and proceeds to ACT 82. The processor 11 performs initialization and ends the information processing indicated by the flowcharts of FIGS. 7 to 11.

If the operator P who finished the work of the first assembly process or the second assembly process held the end medium over the reader 50 in this way as well, the processor 11 creates the work log data 231 and outputs the work log data 231 to the server 20. If the work time T is equal to or longer than the effective work time Tx of the first assembly process or the second assembly process, the effective flag F of the work log data 231 is the value “1” representing effective work. If the work time T is shorter than the effective work time Tx, the effective flag F of the work log data 231 is the value “0” representing ineffective work.

Incidentally, the operator P who starts work of the first work process sometimes extends the hand to the second component area 4 first by mistake and, thereafter, moves the hand to the first component area 3. In such a case, at a stage when the operator P extends the hand to the second component area 4, the processor 11 executes the processing in ACT 43 to ACT 46 in FIG. 9. Therefore, at a point in time when a movement of the hand is detected in the first component area 3, the work code is “200” and the status ST is “1”. Accordingly, the processor 11 determines YES in ACT 27 in FIG. 8. The processor 11 proceeds to ACT 24 and executes the processing in ACT 24 to ACT 26 in the same manner as explained above. That is, the processor 11 describes, in the work data area 122, the work data of the first work process identified by the work code “100”. Further, the processor 11 describes time at the present point in time clocked by the time piece 14 in the log data area 123 as the work start time. Thereafter, the processor 11 starts the timer and returns to the waiting state in ACT 6 to ACT 9.

Similarly, the operator P who starts the work of the second work process sometimes extends the hand to the first component area 3 first by mistake and, thereafter, moves the hand to the second component area 4. In such a case, at a stage when the operator P extends the hand to the first component area 3, the processor 11 executes the processing in ACT 23 to ACT 26 in FIG. 8. Therefore, at a point in time when a movement of the hand is detected in the second component area 4, the work code is “100” and the status ST is “1”. Accordingly, the processor 11 determines YES in ACT 47 in FIG. 9. The processor 11 proceeds to ACT 44 and executes the processing in ACT 44 and ACT 46 in the same manner as explained above. That is, the processor 11 describes, in the work data area 122, the work data of the second work process identified by the work code “200”. Further, the processor 11 describes time at the present point in time clocked by the timepiece 14 in the log data area 123 as the work start time. Thereafter, the processor 11 starts the timer and returns to the waiting state in ACT 6 to ACT 9.

In this way, the data described in the work data area 122 and the log data area 123 because the operator P extends the hand to a wrong component area first by mistake is rewritten by the operator P extending the hand to a correct component area later. Therefore, it is possible to accurately calculate the work time T of the first work process or the second work process.

[Action Effects of the Work Management Apparatus]

As explained above in detail, the processor 11 of the work management apparatus 10 executes the processing in ACT 5 and ACT 6 in FIG. 7 in cooperation with the camera 40 to thereby function as the image acquiring unit 111. The processor 11 executes the processing in ACT 7 in FIG. 7 to thereby function as the image analyzing unit 112. The processor 11 executes the processing in ACT 1 and ACT 9 in cooperation with the reader 50 to thereby function as the reading unit 113.

The processor 11 executes the processing in ACT 25, ACT 29, and ACT 21 to ACT 33 in FIG. 8, the processing in ACT 45, ACT 49, and ACT 51 to ACT 53 in FIG. 9, and the processing in ACT 74 and ACT 76 to ACT 78 in FIG. 11 to thereby function as the first detecting unit 114. The processor 11 executes the processing in ACT 21, ACT 22, and ACT 27 in FIG. 8, the processing in ACT 41, ACT 42, and ACT 47 in FIG. 9, and the processing in ACT 71 and ACT 72 in FIG. 11 to thereby function as the second detecting unit 115. The processor 11 executes the processing in ACT 8, ACT 10, and ACT 12 in FIG. 7 to thereby function as the third detecting unit 116. The processor 11 executes the processing in ACT 35 in FIG. 8, ACT 55 in FIG. 9, and ACT 80 in FIG. 11 to thereby function as the information acquiring unit 117.

With the work management apparatus 10 having such a configuration, for each of the first work process and the second work process, as information concerning work of the operator P for the process, it is possible to acquire the work log data 231 including a time required for the work, that is, the work time T. The work log data 231 includes the effective flag F (F=1) indicating that the work is effective work if the work time T is equal to or longer than the effective work time Tx. The work log data 231 includes the effective flag F (F=0) indicating that the work is ineffective work if the work time T is shorter than the effective work time Tx. That is, the work log data 231 in which the effective flag F is “0” is data at the time when actual work is not performed. Therefore, by analyzing the work log data 231 in which the effective flag F is “0”, it is possible to analyze a factor causing a delay in a work time.

[Modifications]

Lastly, modifications of the embodiment are explained. The modifications are not limited to examples explained below.

In the embodiment, by analyzing an image captured by the camera 40, it is detected that the hand of the operator P entered the work area 2, the first component area 3, and the second component area 4. In this regard, it may be detected using, for example, a well-known infrared sensor that the hands of the operator P entered the areas.

The information relating to the work acquired by the information acquiring unit 117 is not limited to the work time T. For example, the information acquiring unit 117 may acquire, as the information concerning the work, the number of times the operator P extends the hand to the component area during work of one process.

Timing for acquiring the work start time is not limited to the timing of ACT 25 in FIG. 8 or ACT 45 in FIG. 9. For example, the processor 11 may acquire the present time at timing after determining YES in ACT 62 in FIG. 10 or after the processing in ACT 63 and set the present time as the work start time. Consequently, it is possible to exclude, from the work time T, a time required for taking out a component from the component area.

In the embodiment, the work management apparatus 10 that manages work performed in one workbench 1 is illustrated. The work management apparatus 10 may manage kinds of work respectively performed in parallel in a plurality of workbenches 1. In this case, the camera 40 and the reader 50 are provided for each of the workbenches 1. One camera may be provided for two or more workbenches 1. It is also possible to detect a movement of the hand of the operator P for each of the workbenches 1 with image processing.

The first component area 3 and the second component area 4 may not always be present on the workbench 1. For example, the first component area 3 and the second component area 4 may be provided beside the workbench 1 or may be provided in front of the operator P across the workbench 1. In this case, the camera 40 may be divided into a camera that images the work area 2 and a camera that images the first component area 3 and the second component area 4. Cameras may be divided for each of the component areas.

Work is not limited to the assembly work. The work may be, for example, work for disassembling a product or work for performing maintenance of a product. In the case of the disassembly work, component areas are assumed to be an area where tools necessary for the work are prepared and an area where disassembled components and the like are collected. That is, the component areas can be reworded as article areas where articles relating to the work are placed.

The number of processes is not limited to the processes. It goes without saying that the number of processes is also applicable to work including three or more processes.

In the embodiment, the operator P carries the two types of media including the start medium and the end medium. The media may be media including one type of a barcode. That is, the processor 11 of the work management apparatus 10 recognizes, as a barcode of the start medium, a barcode read by the reader 50 first and recognizes, as a barcode of the end medium, a barcode read thereafter if the barcode has the same data as the barcode read first.

The media may be wireless tags. If the media are the wireless tags, the reader 50 is a wireless tag reader. The operator P places a wireless tag storing an operator code on a reading unit of the reader 50 before starting work and picks up the wireless tag if ending the work. The processor 11 proceeds to ACT 2 in FIG. 7 if data reading from the wireless tag starts in the reader 50 and proceeds to ACT 13 if the data reading ends. If such media are adopted, the same action effects as the action effects in the embodiment can be achieved.

A program may be transferred in a state in which the program is stored in an apparatus or may be transferred in a state in which the program is not stored in the apparatus. In the latter case, the program may be transferred via a network or may be transferred in a state in which the program is recorded in a recording medium. The recording medium is a non-transitory tangible medium. The recording medium is a computer-readable medium. The recording medium only has to be a medium capable of storing a program and readable by a computer such as a CD-ROM or a memory card. A form of the recording medium does not matter.

Besides, the several embodiments of the present disclosure are explained above. However, these embodiments are presented as examples and are not intended to limit the scope of the invention. These new embodiments can be implemented in other various forms. Various omissions, substitutions, and changes can be made without departing from the gist of the invention. The embodiments and the modifications thereof are included in the scope and the gist of the invention and included in the inventions described in the claims and the scope of equivalents of the inventions.

What is claimed is:

1. A work management apparatus, comprising:
a first detector configured to detect that work was executed in a work area;
a second detector configured to detect that the work in the work area ended;
a third detector configured to detect that a hand of an operator entered an article area where an article relating to the work is placed; and
an information acquisition component configured to acquire information relating to the work in the work area if, from when the third detector detects that the hand of the operator entered the article area until when the second detector detects that the work in the work area ended, the first detector detects that the work was executed in the work area.

2. The work management apparatus according to claim 1, further comprising:
an image acquisition component configured to acquire a captured image from a camera that images the work area; and
an image analyzing component configured to detect a position of the hand of the operator from the captured image, wherein
if the hand of the operator detected by the image analyzing component is located in the work area for a predetermined time or longer, the first detector detects that the work was executed in the work area.

3. The work management apparatus according to claim 1, wherein
the article area is divided into a plurality of article areas, and
if, after detecting that the hand of the operator entered a first article area, the third detector detects that the hand of the operator entered another second article area, the second detector detects that work relating to an article placed in the first article area in the work area ended.

4. The work management apparatus according to claim 1, further comprising a reading component configured to read medium information, wherein
the second detector detects based on a reading result of the medium information by the reading component that the work in the work area ended.

5. The work management apparatus according to claim 1, wherein the information acquisition component acquires, as a work time in the work area, an elapsed time from a first point in time when the third detector detects that the hand of the operator entered the article area until a second point in time when the second detector detects that the work in the work area ended.

6. The work management apparatus according to claim 1, further comprising a generating component configured to generate work log data from at least one of an operator code, an operator name of an operator data area, a work code, and a work name of the work area, a work start time, a work end time, and a work time.

7. The work management apparatus according to claim 6, wherein the work code is a unique identification code set for each process in order to individually identify processes of assembly work carried out in the work area.

8. A work management method for managing work performed in a work area, comprising:
detecting that work was executed in a work area;
detecting that the work in the work area ended;
detecting that a hand of an operator entered an article area where an article relating to the work is placed; and
acquiring information relating to the work in the work area if, from when the hand of the operator entered the article area is detected until the work in the work area ended is detected, then the work was executed in the work area is detected.

9. The work management method according to claim 8, further comprising:
acquiring a captured image from a camera that images the work area;
detecting a position of the hand of the operator from the captured image; and
if the hand of the operator detected is located in the work area for a predetermined time or longer, detecting that the work was executed in the work area.

10. The work management method according to claim 8, wherein
the article area is divided into a plurality of article areas, further comprising:
if, after detecting that the hand of the operator entered a first article area, detecting that the hand of the operator entered another second article area; and
detecting that work relating to an article placed in the first article area in the work area ended.

11. The work management method according to claim 8, further comprising:
reading medium information; and
detecting, based on a reading result of the medium information, that the work in the work area ended.

12. The work management method according to claim 8, further comprising:
acquiring, as a work time in the work area, an elapsed time from a first point in time when detecting that the hand of the operator entered the article area until a second point in time when detecting that the work in the work area ended.

13. The work management method according to claim 8, further comprising:
generating work log data from at least one of an operator code, an operator name of an operator data area, a work code, and a work name of the work area, a work start time, a work end time, and a work time.

14. A work management system for one or more image forming apparatuses, comprising:
a first detector configured to detect that work was executed in a work area comprising the one or more image forming apparatuses;
a second detector configured to detect that the work in the work area ended;
a third detector configured to detect that a hand of an operator entered an article area where an article relating to the work is placed; and
an information acquisition component configured to acquire information relating to the work in the work area if, from when the third detector detects that the hand of the operator entered the article area until when the second detector detects that the work in the work area ended, the first detector detects that the work was executed in the work area.

15. The work management system according to claim 14, further comprising:
an image acquisition component configured to acquire a captured image from a camera that images the work area; and
an image analyzing component configured to detect a position of the hand of the operator from the captured image, wherein
if the hand of the operator detected by the image analyzing component is located in the work area for a predetermined time or longer, the first detector detects that the work was executed in the work area.

16. The work management system according to claim 14, wherein
the article area is divided into a plurality of article areas, and
if, after detecting that the hand of the operator entered a first article area, the third detector detects that the hand of the operator entered another second article area, the second detector detects that work relating to an article placed in the first article area in the work area ended.

17. The work management system according to claim 14, further comprising a reading component configured to read medium information, wherein
the second detector detects based on a reading result of the medium information by the reading component that the work in the work area ended.

18. The work management system according to claim 41, wherein the information acquisition component acquires, as a work time in the work area, an elapsed time from a first point in time when the third detector detects that the hand of the operator entered the article area until a second point in time when the second detector detects that the work in the work area ended.

19. The work management system according to claim 14, further comprising a generating component configured to generate work log data from at least one of an operator code, an operator name of an operator data area, a work code, and a work name of the work area, a work start time, a work end time, and a work time.

20. The work management system according to claim 19, wherein the work code is a unique identification code set for each process in order to individually identify processes of assembly work carried out in the work area.
